(19) United States
(12) Patent Application Publication
(10) Pub. No.: US 2009/0184041 A1
(43) Pub. Date: Jul. 23, 2009

(54) Fluid filter with clear shell portion

(75) Inventors: Gregory W. Hoverson, Cookeville, TN (US); Kevin C. South, Cookeville, TN (US); Ismail C. Bagci, Cookeville, TN (US); David Dickerson, Livingston, TN (US)

Correspondence Address: HAMRE, SCHUMANN, MUELLER & LARSON, P.C., P.O. BOX 2902, MINNEAPOLIS, MN, 55402-0902, US

(73) Assignee: Cummins Filtration IP, Inc.

(21) Appl. No.: 12/009,965

(22) Filed: Jan. 23, 2008

(51) Int. Cl. B01D 35/30; B01D 27/08

(52) U.S. Cl. 210/232; 210/248; 210/444

(57) ABSTRACT

A fuel-water filter/separator for threaded connection to a mounting base has a shell and a filtering media positioned within the shell. The shell has an open top end and a substantially closed bottom end. The shell is made of an opaque plastic except for a window in the shell made from a substantially clear plastic. The substantially clear plastic in the window being insert molded to the opaque plastic. The filtering media is positioned within the shell for filtering fuel. The shell defines a water collection portion beneath the filtering media, the window of the shell being positioned such that it overlaps at least a part of the water collection portion to allow water level monitoring.

### TECHNICAL FIELD

The technical field relates to filter cartridges and filtration systems, preferably including replaceable filter elements.

### BACKGROUND OF THE INVENTION

Various apparatuses and methods have been utilized for removing suspended contaminants from a contaminated fluid. In general, the contaminated fluid is passed through a porous filtering media by an external pressure or an external force. The pore size of the porous filtering media is selected to permit the passage of the fluid therethrough while inhibiting the flow of contaminants through the porous filtering media. The contaminants are blocked by the porous filter media while the fluid passes through the porous filter media. The fluid flowing through the filter media is purged of the contaminants.

Replaceable filter cartridges and assemblies have proven to be useful components of filtration systems for a variety of applications including, for example, internal combustion engines such as diesel engines. Replaceable filter elements can be coupled with other components of filtration systems to provide assemblies operable to remove particulates and other undesirable matter from fluids.

### SUMMARY OF THE INVENTION

A fuel-water separator filter for threaded, spin-on connection to a mounting base according to one embodiment of the present invention comprises a nutplate section constructed and arranged for connection to the mounting base, a shell spin-welded to the nutplate section, the shell being constructed and arranged as a molded plastic component; and filtering media positioned within the shell for filtering fuel, the shell including a clear water collection portion that is insert molded into the remainder of the shell for providing a water level monitoring capability.

In another embodiment of the present invention there is an engine filter component for liquids. A substantially clear plastic shell section extends between an open first end and a second end. The first end of the clear section is connected to an opaque plastic nutplate section by a spin welded joint.

In one refinement the substantially clear shell section is annular.

In another refinement the substantially clear shell section is a polyamide material.

In another refinement the second end is substantially closed and the second end defines at least two ports. The nutplate section is made from nylon.

In another embodiment of the present invention there is a filter shell comprising a bottom section and a top section. At least a portion of the bottom section is made from a substantially clear plastic. The top section has an open top end and is made from an opaque plastic. The bottom section is insert molded to the top section.

In one refinement the top end of the opaque top section is connected to a nutplate section at a spin welded joint.

In another refinement the nutplate section is made from nylon. The opaque plastic material is selected to be capable of a stronger spin welded joint connection to the nutplate than a spin welded joint between the substantially clear plastic and the nutplate.

In another refinement the opaque plastic top section defines external threads substantially adjacent to the open top end.

In another refinement the bottom section has a substantially closed bottom end that defines a drain valve opening.

In another refinement the first plastic is a polyamide material known by the trade name Grilamid TR55 LX.

In another refinement the entire bottom section is made from the substantially clear plastic.

In another refinement the bottom section defines a plurality of external ribs. The bottom section and the opaque plastic top section both extend along an axis and have a total length of which the bottom section comprises about ¼ to ⅓ of the total length and the opaque plastic top section comprises about ¾ to ⅔ of the total length.

In another refinement only the portion of the bottom section is made from the substantially clear plastic and the remainder of the bottom section is made from the opaque plastic.

In another embodiment of the present invention there is a fuel-water filter/separator for threaded connection to a mounting base that has a shell and a filtering media positioned within the shell. The shell has an open top end and a substantially closed bottom end. The shell is made of an opaque plastic except for a window in the shell made from a substantially clear plastic. The substantially clear plastic in the window being insert molded to the opaque plastic. The filtering media is positioned within the shell for filtering fuel. The shell defines a water collection portion beneath the filtering media, the window of the shell being positioned such that it overlaps at least a part of the water collection portion to allow water level monitoring.

In one refinement the open top end of the shell is spin-welded to a nutplate section.

In another refinement the nutplate is made from nylon, and the opaque plastic is selected to be capable of a stronger spin welded joint connection to the nutplate than a spin welded joint between the substantially clear plastic and the nutplate.

In another refinement the opaque plastic defines external threads substantially adjacent to the open top end.

In another refinement the substantially clear plastic is a polyamide material known by the trade name Grilamid TR55 LX.

In another refinement the window extends around an entire circumference of the shell closer to the bottom end than to the top end.

In another refinement the window extends from a point between the top end and the bottom end all the way to and including the bottom end.

One object of the present invention is to provide an improved fuel-water separator filter.

Related objects and advantages of the present invention will be apparent from the following description.

### BRIEF DESCRIPTION OF THE FIGURES

FIG. 1 is a side view of a vehicle including an engine and a filtration system.

FIG. 2 is a top perspective view of an embodiment of the present invention including a clear shell portion.

FIG. 3 is a side view of an embodiment of the present invention including a clear shell portion.

FIG. 4 is a side view of another embodiment of the present invention including a clear shell portion.

FIG. 5 is a side view of another embodiment of the present invention including a clear shell portion.

### DETAILED DESCRIPTION OF THE PREFERRED EMBODIMENTS

For purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

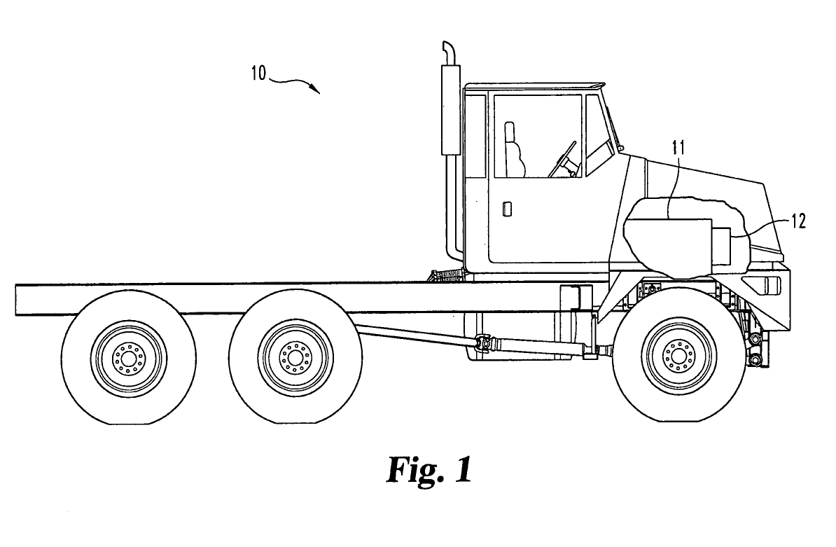

With reference to FIG. 1 there is illustrated a vehicle 10. Vehicle 10 could be a variety of types of vehicles, for example, a light duty truck, a medium duty truck, a heavy duty truck, a passenger vehicle, a bus, or an industrial or construction vehicle. Vehicle 10 includes an engine 11, which is preferably a diesel engine but could be other types of internal combustion engines, and a filtration system 12 which is in flow communication with engine 11 and is operable to filter fluids to be provided to engine 11. Filtration system 12 could be the same as or similar to filtration systems described herein or components thereof.

The present invention relates generally to a filter that can be used, for example, with internal combustion engines, such as diesel or gasoline powered engines. Such filter units are important since various fluids used in vehicle engines are susceptible to being contaminated by water, sand, dirt and other particulate materials. Impurities such as products of combustion, soot, moisture, dust, abrasion powder, etc. mix with the lubricating oil every moment during the operation of an automobile's engine and the impurities are filtered by the filter assembly. Thus, there are many applications for filters according to the present invention. For example, the filter assembly can be used for farm equipment, construction equipment, skidders, loaders, other off-road vehicles, heavy-duty highway trucks, automobiles, and other vehicles, industrial machines requiring hydraulic filtering, and all other equipment or mechanical devices that require the filtering of fluids. Additionally, the filter assembly can be used to remove foreign matter from a variety of different fluids. Examples of liquid fluids include hydraulic fluids, engine lubrication oil, diesel fuel, gasoline, engine coolant, automatic transmission fluid, and any other type of fluid. Filter assemblies can also be used with gaseous fluids such as air and exhaust.

The present invention relates in general to fluid filters, including those that are constructed and arranged for spin-on attachment to a base. More specifically, one embodiment of the present invention relates to fuel filters that are constructed and arranged with a water separation capability. Prior art fuel filters of the type generally described herein often include a clear bowl as a separate attachment for water level monitoring. The water level monitoring bowl is typically attached to the fluid filter shell by means of a threaded connection. Since this style of design requires a separate bowl, this design introduces added cost and added time to the final product in terms of assembly and testing. Moreover, using a separate clear bowl as an attachment for water monitoring introduces a threaded connection interface with the fuel filter shell. Importantly, this connection interface needs to be properly sealed such that there is no fluid leakage. This in turn introduces a design challenge since the connection interface introduces the risk for one or more leakage paths through the interface. Potentially, there is a need for a separate seal or gasket in the area of this connection interface and, if utilized, this adds to the overall manufacturing complexity and the overall cost. This is true whether a threaded connection is used to connect the shell and separate bowl or some other connection technique is used.

As noted, some current metal spin-on fuel water separators employ the use of a clear bowl attachment for water level monitoring. This style of design requires a separate bowl and also adds additional leak paths, seals, and a significant degree of cost of manufacturing complexity. The Mach style filter design developed by Cummins Filtration Inc. (previously known as Fleetguard Inc.) is an all plastic filter design. Since the base filter is already plastic, if operating pressures are acceptable clear plastic might be used in the shell in whole or in part to create a transparent shell for use, for example, as a water monitoring window. All embodiments of the present invention discussed herein are preferably am all plastic filter design.

In one embodiment of the present invention there is a Mach style filter (Mach 1 or Mach 2, nutplate or no-nutplate style, respectively) with an integrally molded clear shell portion for use in fuel water separators as a water monitoring “window.” It should be understood variations on this embodiment are contemplated as within the scope of the invention. Substantially all of the shell might act as a window, but preferably only a portion thereof. The portion might be a section extending around the entire perimeter of the shell, or only an arc portion. The window might be circular, oval, square, rectangular or some other polygon shape, or might be a polygon with rounded edges.

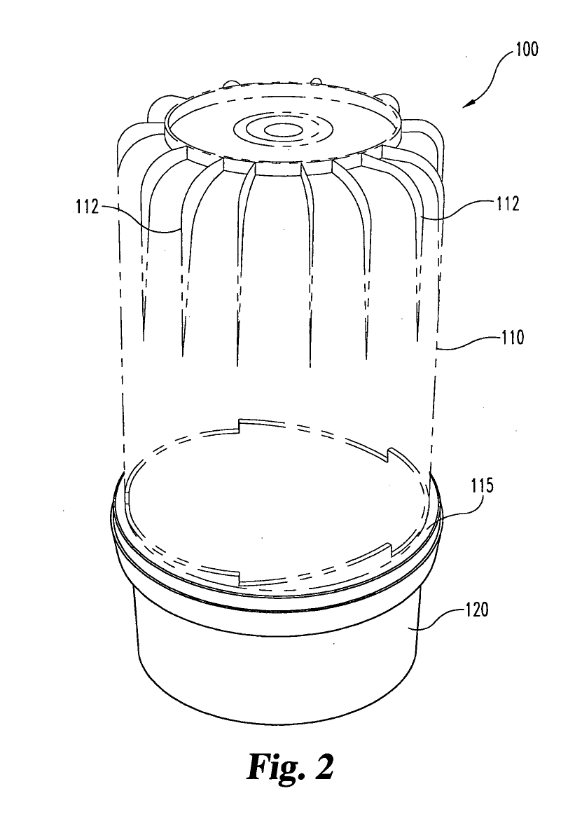

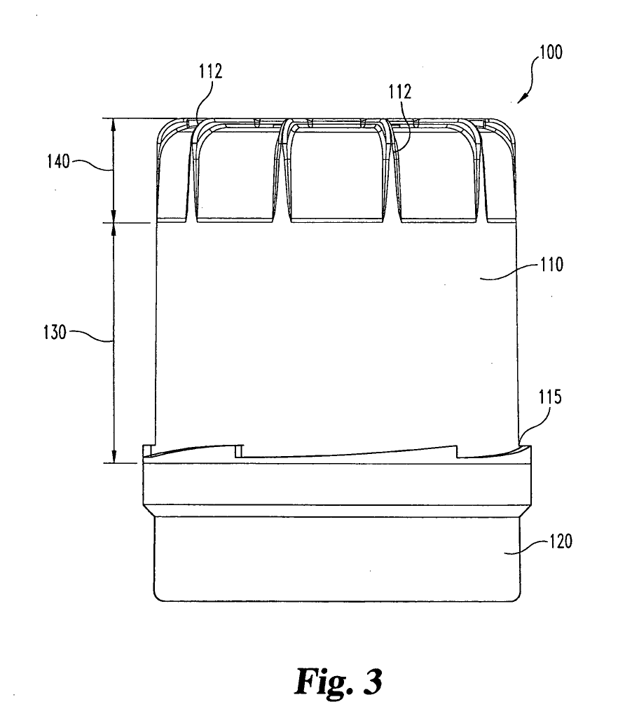

FIGS. 2 and 3 illustrate a Mach 1 style spin-on filter 100 with the shell portion 110 having a plurality of external ribs 112. Shell portion 110 is built from transparent plastic and spin-welded at joint 115 to a nutplate section 120. Thus, unitary spin-on filter 100 has water monitoring capabilities without the use or need of additional components that traditional spin-on filters require. As stated earlier, the filter 100 might be made with an entirely transparent plastic shell 110. However, to save on cost, it is preferred that only a small portion of the filter shell 110 be made from the more expensive transparent plastic. In one embodiment this might be done by insert molding the clear plastic “bottom shell” section to less expensive (opaque) plastic material creating a single “two-piece” unitized shell that is ultimately spin-welded to the nutplate portion.

Utilizing the same or similar material in the top portion of the shell as used in the nutplate also facilitates a stronger and more robust spin-weld; however, through proper material selection the transparent plastic can be effectively spin-welded to the nutplate portion if desired. A clear plastic shell can be used in the Mach 1 or Mach 2 style of design if the application pressures are sufficiently moderate to allow the use of the generally weaker substantially clear or clear plastic material. Initial welding trials were performed for a design in the style of FIGS. 2 and 3 which were then subjected to a hydrostatic burst test to test the spin weld joint integrity. The burst test results indicated that the joint bonded adequately since the first point of failure was within the base material itself. This testing validated that from a design perspective a spin weld of substantially clear or clear plastic material can be made strong enough (even as strong as the base material as indicated by the hydrostatic burst test). In one test on a clear shell design manufactured from Grilamid TR55LX (using spin welding techniques to bond the clear plastic shell to a black nylon nutplate section), the hydrostatic burst test resulted in a burst at 270 psi and average hydrostatic burst results were above 230 psi. Grilamid TR55 LX is a polyamide 12 type material. However, it should be understood that other clear or substantially clear materials are contemplated as within the scope of the invention. Other examples believed to be potentially useful include, but are not limited to, the Grivory GTR45 polyamide copolymer and Isoplast 302EZ which is a thermoplastic polyurethane. Despite increasing costs in clear plastic material the improved manufacturing process allowed by this design reduces the overall cost compared to a traditional threaded attached clear bowl.

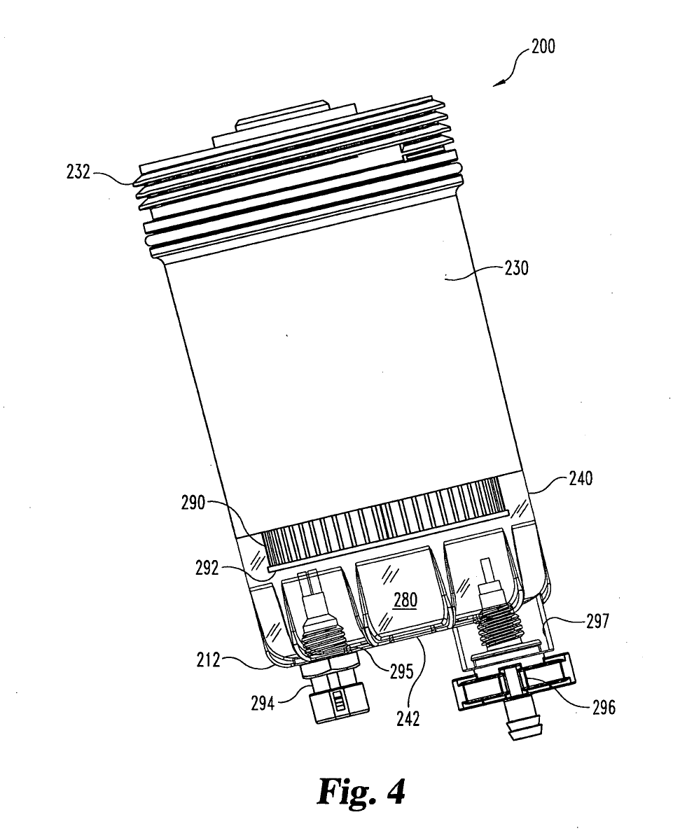

With reference to FIG. 4 there is illustrated the use of clear or substantially clear plastic in a Mach 2 filter application. The filter shell 200 preferably includes a top portion 230 made from an opaque plastic. Substantially adjacent to the open top end (which might include at the top end), the top portion 230 defines external threading 232. The top portion 230 is preferably integrally connected to substantially clear or clear plastic bottom portion 240. The bottom portion 240 preferably includes a plurality of external ribs 212 that terminate at a substantially closed end 242. The substantially closed end 242 preferably defines a port 295 and a second port 297. A water in fuel sensor 294 is received within port 295. A drain valve 296 is received within port 297.

Received within the shell 200 is a filter media 290. Filter media 290 is illustrated as being an annular pleated filter media extending between a bottom endplate 292 and a top endplate (not illustrated). It should be understood, however, that other types of filter media are contemplated as within the scope of the invention. The shell 200 defines a water collection portion 280 beneath the filtering media 290.

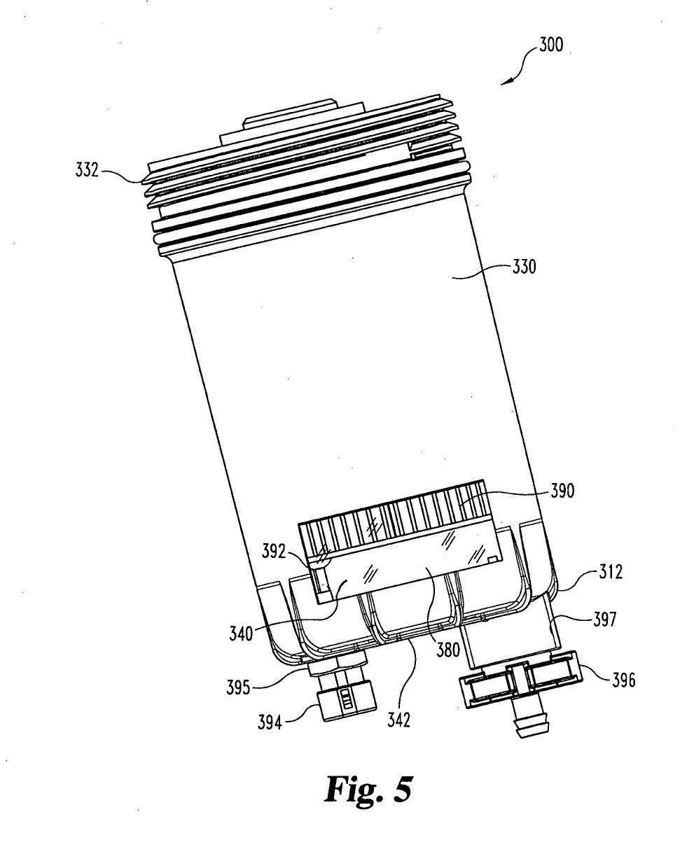

With reference to FIG. 5 there is illustrated the use of clear or substantially clear plastic in another embodiment of a Mach 2 filter application. The filter shell 300 preferably includes a top portion 330 made from an opaque plastic. Substantially adjacent to the open top end (which might include at the top end), the top portion 330 defines external threading 332. The top portion 330 is connected to bottom portion that includes a substantially clear panel 340. The bottom portion preferably includes a plurality of external ribs 312 that terminate at a substantially closed end 342. The substantially closed end 342 preferably defines a port 395 and a second port 397. A water in fuel sensor 394 is received within port 395. A drain valve 396 is received within port 397.

Received within the shell 300 is a filter media 390. Filter media 390 is illustrated as being an annular pleated filter media extending between a bottom endplate 392 and a top endplate (not illustrated). It should be understood, however, that other types of filter media are contemplated as within the scope of the invention. The shell defines a water collection portion 380 beneath the filtering media 390. The panel 340 is made of a substantially clear plastic, and overlaps at least a portion of the water collection portion 380 within the shell 300. Alternatively, as in the embodiment of FIG. 4, a window can encompass the entirety of the bottom section of the shell.

While aspects of the description herein refer to Mach filters sold by Cummins Filtration Inc., such is intended merely as a non-limiting example of one application of the present invention. Similarly, as discussed above, various embodiments of the present invention might find application with filtration of a number of different fluids. However, currently the most preferred application involves fuel filtration. This is because most clear material uses minimal to no filler for strength (such as glass or mineral fills). Lower strength materials are generally used in low pressure applications where water separation is usually done. Various embodiments of the present invention previously described thus allow one to visually see the level of the water in conjunction with the fuel. Higher pressure systems usually hinder the fuel separation due to the excessive flow and rentrainment of water into the system. However, various embodiments of the present invention might also find application in viewing fluid levels for various other filtration systems. Similarly, various embodiments of the present invention might be used to visually identify some type of media or cartridge, filtration level imprinted on the cartridge, or even brand and quality of media.

Utilizing a clear or transparent material for all or a portion of the shell allows the design to incorporate a clear water collection bowl as an integral or unitary portion of the primary or main fuel filter shell. Presently, material cost considerations likely limit the desire to have the entire shell be made from clear or substantially clear plastic. However, having only select portions of the shell made out of a clear or transparent material is an option, as contemplated by the present invention and disclosed in the various embodiments (see FIGS. 4 and 5).

One embodiment of the present invention is a unitary fuel filter shell that has sufficient strength and rigidity to permit the use of a transparent, molded plastic material for the entire fuel filter shell. Both the fuel filter portion and the water collection bowl portion of the shell are configured as a single, unitary component. This unitary construction precludes the need for a separate bowl component and eliminates the need for a connection interface. This in turn saves cost and assembly time and eliminates the risk of concern regarding fluid leakage through or around the connection interface. As noted, currently the available clear plastics that have sufficient strength for a unitary shell may present a cost consideration. However, this may change as new plastics become available.

In a related embodiment of the present invention, the fuel filter shell is fabricated by an insert molding process. Insert molding allows the use of a less expensive plastic material for the upper body of the shell and the use of the desired transparent or clear plastic material for the lower water collection portion of the shell, while still effectively having an integrally molded component that could be considered a unitary component, although molded in two steps or stages.

In terms of the clear material portion that is insert molded as part of or into the opaque shell, several shapes and sizes are contemplated as part of the present invention. In one embodiment of the present invention, a 360 degree annular portion is provided for monitoring the water collection. In other embodiments of the present invention, the clear plastic material that is insert molded into the fluid filter shell is shaped into viewing portion that extends for substantially less than a full 360 degrees. This clear portion or panel is insert molded into the opaque plastic body that constitutes the remainder of the fluid filter shell. Contemplated shapes for this clear panel include, among others, square, rectangular, circular, and oval.

The opaque plastics that are suitable to be used for the fluid filter shell and the plastics that are suitable for the clear window are generally not considered to be molecularly compatible in order to meld together with a unitized joint during the insert molding process. While some joining of the two plastic materials may occur as the molten opaque plastic contacts the inserted clear plastic, this joint will not always be strong enough to withstand the internal operating pressures to be experienced by the fluid filter. Thus, the interface edges around the outer periphery of the clear panel are preferably shaped and configured in some fashion to add strength to the interface joint by means of some type of mechanical interfit or interlock. By shaping the peripheral outer edges of the clear panel, the opaque plastic is able to flow into and around these mechanical forms and thereby interlock and hold the clear panel within the opaque plastic in a stronger and more secure fashion with a joint that is sufficient to withstand the internal operating pressures of the fluid filter without any cracking, separation, or leakage. This particular mechanical edge configuration for the clear window, in order to achieve the requisite strength and rigidity of the joint, might be preferred in some embodiments of the present invention depending on the materials selected.

The spin-on connection to a base utilizes a nutplate section in one embodiment of the present invention. The shell is spin welded to this nutplate section and either plastic material, clear or opaque, can be used for the spin-weld connection. Some of fluid filter designs eliminates the typical nutplate and instead use an enlarged threaded insert at the open end of the shell. The various embodiments of the present invention are suitable for either style of fluid filter, either with a nutplate or without a nutplate and the use of a threaded insert.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. An engine filter component for liquids comprising:
a substantially clear plastic shell section extending between an open first end and a second end, wherein the first end of the clear section is connected to an opaque plastic nutplate section by a spin welded joint.

2. The filter component of claim 1, wherein the substantially clear shell section is annular.

3. The filter component of claim 2, wherein the substantially clear shell section is a polyamide material.

4. The filter component of claim 3, wherein the second end is substantially closed and wherein the second end defines at least two ports, and wherein the nutplate section is made from nylon.

5. A filter shell comprising:
a bottom section, at least a portion of the bottom section made from a substantially clear plastic;
a top section having an open top end, the top section made from an opaque plastic; and
wherein the bottom section is insert molded to the top section.

6. The filter shell of claim 5, wherein the top end of the opaque top section is connected to a nutplate section at a spin welded joint.

7. The filter shell of claim 6, wherein the nutplate section is made from nylon, and wherein the opaque plastic material is selected to be capable of a stronger spin welded joint connection to the nutplate than a spin welded joint between the substantially clear plastic and the nutplate.

8. The filter shell of claim 5, wherein the opaque plastic top section defines external threads substantially adjacent to the open top end.

9. The filter shell of claim 8, wherein the bottom section has a substantially closed bottom end that defines a drain valve opening.

10. The filter shell of claim 5, wherein the first plastic is a polyamide material known by the trade name Grilamid TR55 LX.

11. The filter component of claim 5, wherein the entire bottom section is made from the substantially clear plastic.

12. The filter shell of claim 11, wherein the bottom section defines a plurality of external ribs, and wherein the bottom section and the opaque plastic top section both extend along an axis and have a total length of which the bottom section comprises about ¼ to ⅓ of the total length and the opaque plastic top section comprises about ¾ to ⅔ of the total length.

13. The filter shell of claim 5, wherein only the portion of the bottom section is made from the substantially clear plastic and the remainder of the bottom section is made from the opaque plastic.

14. A fuel-water filter/separator for threaded connection to a mounting base comprising:
a shell having an open top end and a substantially closed bottom end, the shell made of an opaque plastic except for a window in the shell made from a substantially clear plastic, the substantially clear plastic in the window being insert molded to the opaque plastic;
a filtering media positioned within the shell for filtering fuel; and
wherein the shell defines a water collection portion beneath the filtering media, the window of the shell being positioned such that it overlaps at least a part of the water collection portion to allow water level monitoring.

15. The fuel-water filter/separator of claim 14, wherein the open top end of the shell is spin-welded to a nutplate section.

16. The fuel-water filter/separator of claim 15, wherein the nutplate is made from nylon, and wherein the opaque plastic is selected to be capable of a stronger spin welded joint connection to the nutplate than a spin welded joint between the substantially clear plastic and the nutplate.

17. The fuel-water filter/separator of claim 14, wherein the opaque plastic defines external threads substantially adjacent to the open top end.

18. The fuel-water filter/separator of claim 14, wherein the substantially clear plastic is a polyamide material known by the trade name Grilamid TR55 LX.

19. The fuel-water filter/separator of claim 14, wherein the window extends around an entire circumference of the shell closer to the bottom end than to the top end.

20. The fuel-water filter/separator of claim 19, wherein the window extends from a point between the top end and the bottom end all the way to and including the bottom end.
